(19) United States
(12) Patent Application Publication
(10) Pub. No.: US 2019/0012669 A1
(43) Pub. Date: Jan. 10, 2019

(54) Security System Using Communication Channel-Based Authorization

(71) Applicant: Microsoft Technology Licensing, LLC, Redmond, WA (US)

(72) Inventors: Malcolm Erik PEARSON, Kirkland, WA (US); Tolga ACAR, Sammanish, WA (US)

(21) Appl. No.: 15/645,663

(22) Filed: Jul. 10, 2017

(51) Int. Cl. G06Q 20/40

(52) U.S. Cl. CPC G06Q 20/4014

(57) ABSTRACT

A first communication of a channel communication between a first party and a second party is received for a previous transaction in which the first party provided information for a payment instrument. The information for the payment instrument is stored with the information for the first communication of the channel communication of the previous transaction in storage. A current transaction between the first party and the second party using a second communication is detected. The information for the second communication is used to locate the information for the first communication for the previous transaction and the information for the payment instrument in the storage. The second communication and the first communication are evaluated to determine whether to authorize re-use of the information for the payment instrument for the current transaction. The information for the payment instrument is provided to the first party for use in the current transaction.

### BACKGROUND

Security is important when authorizing transactions between a first party and a second party. To complete a transaction between the first party and the second party, a user may be asked to enter information for a payment instrument, such as a credit card. A system can then authorize the use of the information for the payment instrument to complete the transaction. At this point, the system may offer the user the chance to create an account to save the information for the payment instrument. However, this typically requires that the user provide some credentials for security, such as a username and password. In some instances, the user may decide to not create an account to store the information for the payment instrument for future transactions. For example, the extra steps to create the account may be inconvenient for a user. Subsequently, if the user wants to complete another transaction with the second party, the user would have to enter in the information for the payment instrument again. Having to reenter the information may also be inconvenient for the user and slows down the processing of the transaction.

### BRIEF DESCRIPTION OF THE DRAWINGS

FIG. 1 depicts a simplified system for performing channel-based security for transactions between a first party device and a second party device according to some embodiments.

FIG. 2 depicts an example of a previous transaction using a channel communication according to some embodiments.

FIG. 3A depicts an example of processing a current transaction according to some embodiments.

FIG. 3B depicts an example of locating a record of a channel communication in storage according to some embodiments.

FIG. 4 depicts an example of a system for performing mitigation according to some embodiments.

FIG. 5 depicts an example of a channel communication according to some embodiments.

FIG. 6 depicts a simplified flowchart for processing a previous transaction according to some embodiments.

FIG. 7 depicts a simplified flowchart of a method for processing a current transaction according to some embodiments.

FIG. 8 depicts a simplified block diagram of an example computer system according to certain embodiments.

### DETAILED DESCRIPTION

Described herein are techniques for a security system. In the following description, for purposes of explanation, numerous examples and specific details are set forth in order to provide a thorough understanding of some embodiments. Some embodiments as defined by the claims may include some or all of the features in these examples alone or in combination with other features described below, and may further include modifications and equivalents of the features and concepts described herein.

A security system authorizes transactions between a first party device and a second party device. The first party device may be associated with a first party (e.g., a user) and the second party device may be associated with an entity (e.g., a company). The first party may be a payer that provides a payment to a second party that may be a payee that receives the payment. In some examples, the first party may be purchasing a good or service from the second party using a payment instrument, such as a credit card, bank account, or other payment means.

The security system authorizes a re-use of information for a payment instrument that the first party submitted in a previous transaction. The authorization is performed where the first party was not required to create an account with the security system to save and re-use the information for the payment instrument. Rather, the security system uses a record of a channel communication from the previous transaction to authorize the re-use of the information for the payment instrument in a current transaction. Using the record of the channel communication provides security for the first party and also increases the speed of authorizing the transaction.

In some examples, the first party and the second party may have participated in the previous transaction in which the first party communicated with the second party via a channel communication to complete the transaction. The channel communication may be one or more communications in a channel, such as a thread of emails, chat conversation, website session, and short message service (SMS) conversation. In the transaction, the first party submitted information for a payment instrument to complete the transaction. For example, a user may have been provided an opportunity to submit information for the payment instrument to complete the transaction and subsequently submitted the information for the payment instrument.

The security system stores the information for the payment instrument in addition to a record of the channel communication. The first party does not need to create an account with the payment service that requires credentials, such as login information (e.g., a username) and a password to store the information for the payment instrument. Rather, the first party remains anonymous to the security system. In a subsequent transaction, the security system can detect a current transaction being performed in the same channel communication based on the record of the channel communication from the previous transaction. For example, the same channel communication may be an email thread to an email address for the first party being used again, an SMS conversation to the same telephone number for the first party being continued, or an instant message (IM) chat being continued between the first party and the second party. Additional channel communications may include bot conversations between a bot and a user where a bot is an automated response module. Also, a browser session may be used, such as when a session using an Internet browser is continued to perform a purchase before the session expires.

The security system may analyze the record of the channel communication to determine whether to authorize the re-use of the information for the payment instrument again. The authorization may be based on the strength of a security rating that the security system calculates. For example, the strength of the security rating is based on factors that indicate whether or not the first party in the current transaction is the same party that submitted the information for the payment instrument previously using the channel communication. The security system can then authorize the re-use of the information for the payment instrument in the current transaction based on the security rating. When authorized, the security system automatically offers the first party the opportunity to re-use the information for the payment instrument in the current transaction.

The authorization provides a faster transaction because the user does not have to re-enter the information for the payment instrument again or login into the service. Further, authentication of the user's identity is not performed because the first party did not sign up with the security system, but security is provided by evaluating the channel record for the channel communication. Further, the security system may provide different mitigation mechanisms that may mitigate the risk that the re-use of the information for the payment instrument should not have been authorized.

System

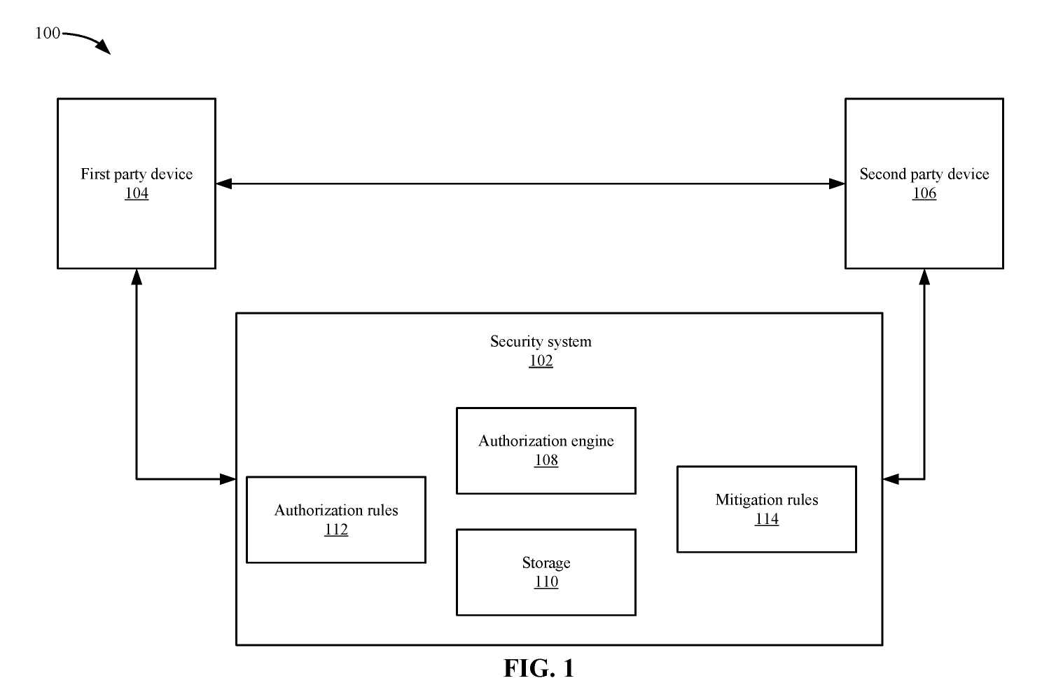

FIG. 1 depicts a simplified system 100 for performing channel-based security for transactions between a first party device 104 and a second party device 106 according to some embodiments. Although first party device 104 and second party device 106 are referred to and discussed, it will be understood that a first party may be using multiple first party devices 104 and a second party may be using multiple second party devices 106 to perform transactions.

A first party may be a user that is a payer, such as the user may be purchasing a good or service from the second party, which may be a payee. Although a purchase may be described, some embodiments may be used between different parties that require transfer of a monetary value to be performed and authorized. For example, the first party may be a first user and the second party may be second user where the first user may be sending money to the second user without the purchase of a good or service.

First party device 104 may participate in a communication with second party device 106 through a channel communication. A channel may be a method of communicating between the first party and the second party. Examples of a channel include email, SMS, chat conversations, bot conversations, and website browsing sessions. The channel communication may be associated with the first party. For example, the channel communication may be associated with an identifier that uniquely identifies the channel communication, such as an email address for the first party, a username for a chat conversation, or a telephone number for an SMS conversation. Some degree of privacy may also be needed for the channel communication. For example, the channel communication may not be publicly detectable, such as the communications are always transferred using a secure mechanism, such as secure socket layer (SSL). Without this privacy, authorization of the re-use of the information for the payment instrument may not be available.

When performing a transaction, the first party may be asked to provide information for a payment instrument in the channel communication. Then, a security system 102 includes an authorization engine 108 that can authorize the use of a payment instrument in a transaction between the first party and the second party. For example, security system 102 may be situated in between first party device 104 and second party device 106 where security system 102 receives and forwards emails between first party device 104 and second party device 106. In some examples, security system 102 may be an intermediary or proxy for the communications. In other embodiments, a communication, such as an email, may include a link that redirects the first party to security system 102. For example, an email may be sent from the second party to the first party requesting that information for the payment instrument be entered. When the first party selects the link, the first party is redirected to security system 102 to enter in the information for the payment instrument. Other examples to allow the first party to enter in the information for the payment instrument may also be provided, such as the user may enter in the information for the payment instrument directly in the email, which can be sent back to security system 102 and/or the second party device 106.

The first party may not create an account with security system 102 to re-use the information for the payment instrument in a subsequent transaction. For example, the creation of an account requires user authentication information to be used, such as a username and password. By not creating an account, the first party in a security system 102 does not have a relationship or agreement, such as a master service agreement (MSA) between each other. This situation may be referred to as a “guest checkout” where the user does not create an account with the second party and/or security system 102 and remain anonymous to security system 102. However, security system 102 may be able to save the information for the payment instrument in addition to a record of the channel communication for the channel communication within storage 110. Consent from the first party to store the payment instrument may be received by security system 102. This may include the user agreeing to an end user license agreement. This consent to store the payment instrument may be different from a user having to create an account with other user credentials, such as a username and password with security system 102. The first party, e.g., a user, may request the removal of one, more, or all of the stored payment instruments from the second party (e.g., storage 110) at any time without any reason. The second party could use the same security mechanisms described herein to verify that the removal request comes from the same user, and executes the request. The removal of a payment instrument does not result in a charge or disclosure of payment information. Thus, the security sensitivity is less, with only a potential inconvenience of a missing payment instrument when the first party expected it where the payment instrument may have been maliciously removed. For example, the record of the channel communication may store information for at least a portion of the conversation between first party device 104 and second party device 106. In some embodiments, this may be content from an email thread between first party device 104 and second party device 106 in which the first party entered the information for the payment instrument. The record may include a channel communication identifier that identifies the channel communication between the first party and the second party. For example, an email thread may have a thread identifier that identifies the email thread between the first party and the second party. Other examples of identifiers include user names, phone number, and email addresses.

At a subsequent time, the first party and the second party may communicate to perform a current transaction. This communication may be using the same channel communication as the previous transaction. For example, the current transaction may use the same email address, the same telephone number in an SMS conversation, or the same username in a chat as in a previous transaction. It is noted that the first party device 104 or second party device 106 may or may not be the same device that was used in the previous transaction in the current transaction. For example, the first party may use a cellular phone for the previous transaction and then a laptop computer for the current transaction, but uses the same email address.

When the first party is prompted to enter information for the payment instrument for the current transaction, authorization engine 108 may use the record of the channel communication from storage 110 to determine whether or not the information for the payment instrument from the previous transaction can be re-used. For example, authorization engine 108 may use authorization rules 112 to determine whether the information for the payment instrument can be authorized for re-use in the current transaction. In some embodiments, authorization engine 108 evaluates authorization rules 112 against the current channel communication and the record of the channel communication to determine whether or not to authorize the re-use of the information for the payment instrument. The authorization process will be described in more detail below, but briefly, authorization engine 108 may use the record of the channel communication to evaluate whether or not the same first party that participated in the previous transaction is now participating in the current transaction. Depending on the evaluation, security system 102 may or may not provide the option for the first party to re-use the information for the payment instrument in the current transaction.

The authorization of the re-use of the information for the payment instrument may provide a faster processing of the current transaction for the first party. For example, the first party would not need to re-enter the information for the payment instrument. Further, authorization engine 108 does not require the first party to enter any authentication information (e.g., login and password). However, authorization engine 108 provides security for the re-use by analyzing the channel communication for the previous transaction. This provides a convenient service to the first party because the user does not need to sign up for a service to re-use information for a payment instrument, but also provides security for the first party using the channel communication from the previous transaction.

However, there may be some risk in the re-use of information for the payment instrument without the user having to provide authentication information for the current transaction. Security system 102 may use mitigation rules 114 to mitigate the risk. The mitigation may provide different mechanisms that will be discussed below that can mitigate the risk of the re-use of the information for the payment instrument. Security system 102 may provide different options for the mitigation risk to first party device 104 and/or second party device 106.

Previous Transaction Using a Channel Communication

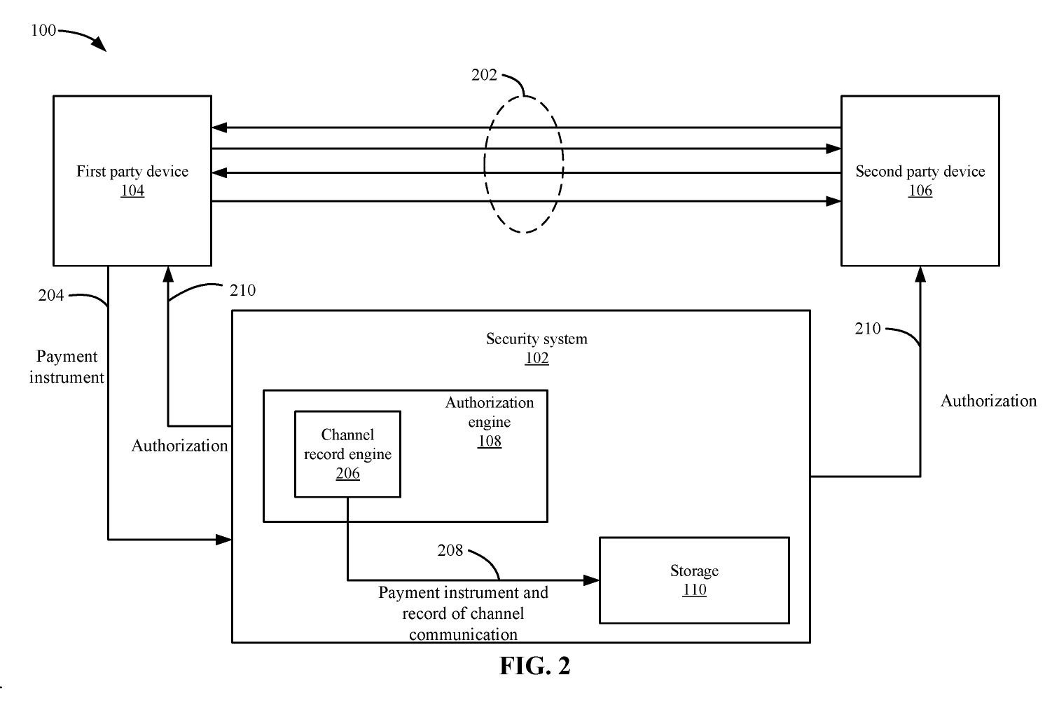

FIG. 2 depicts an example of a previous transaction using a channel communication according to some embodiments. This communication may be between first party device 104 and second party device 106 to perform a payment from the first party to the second party. The previous transaction may be any transaction before the re-use of the information for the payment instrument is offered, such as the initial transaction between the first party and the second party or one of multiple previous transactions in a channel communication.

At 202, communications between first party device 104 and second party device 106 occur using a channel communication. For example, the channel communication may be a thread of emails, a chat conversation, etc. The channel communication may have a common channel communication identifier that makes the communications related. For example, an email thread may have a thread identifier that applies to all the emails that are using the channel communication between a first email address for the first party and a second email address for the second party. For example, a reply or reply-all may be used between first party device 104 and second party device 106 to continue the email thread using the channel communication.

Second party device 106 may send a request for payment of a transaction to first party device 104 in the channel communication. For example, second party device 106 sends the payment request to an email address, username, or telephone number of the first party. The email may allow the first party to submit information for a payment instrument to complete the payment. For example, the first party may select a link in the email that may re-direct the first party to security system 102 to complete the payment. Then, the first party may submit the information for the payment instrument and security system 102 may authorize the use of the payment instrument in the transaction. For example, at 204, first party device 104 may send the information for the payment instrument to security system 102 and security system 102 authorizes the use of the information for the payment instrument.

As discussed above, the first party is not required to create an account with security system 102 to save the information for the payment instrument. However, a channel record engine 206 may store the information for the payment instrument and a record for the channel communication in storage 110 at 208. For example, channel record manager 206 may create an entry in a database table to store the information for the payment instrument. In some embodiments, the record of the channel communication may include information that can be used to identify the channel communication, such as one or more identifiers that uniquely identify the communication at 202 or the entire content (or portion) of the email thread. In some examples of an email channel communication, a combination of one or more of a “From” email address, a “To” email address, an email identifier, and/or a thread identifier may be used to identify the email channel communication. The thread identifier may identify the thread that associates a group of emails between two email addresses together. The email identifier may identify the email in the sequence of identifiers, such as the first email of the thread may have an email identifier of #1, the second email of the thread may have an email identifier of #2, and so on. The To email address is the first party's email address and the From email address is the second party's email address.

To complete the transaction, at 210, security system 102 may send a confirmation that the information for the payment instrument provided by the first party is authorized to first party device 104 and/or second party device 106. The transaction may then be completed between first party device 104 and second party device 106.

Current Transaction

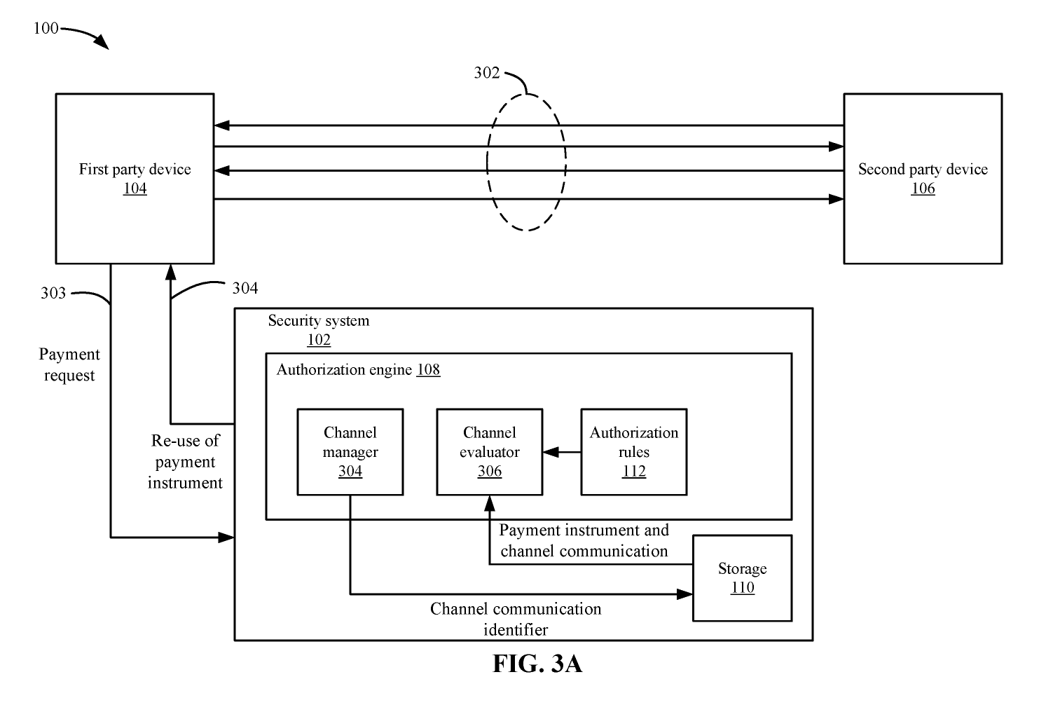

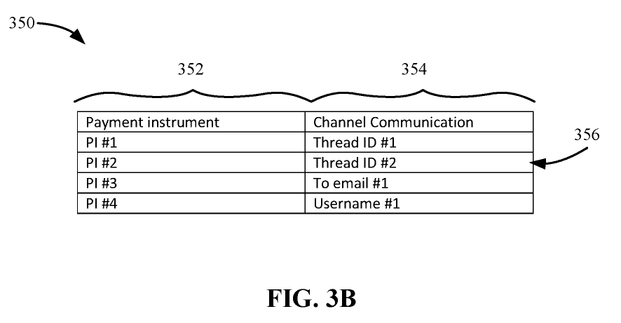

FIG. 3A depicts an example of processing a current transaction according to some embodiments. At 302, first party device 104 and second party device 106 participate in a channel communication for the current transaction. In some examples, this channel communication may be a continuation of an email thread, a chat conversation, or an SMS conversation from the previous transaction. Different ways may be used to identify this communication as a continuation of a previous channel communication. For example, a channel communication identifier may be common to both the previous channel communication for the previous transaction and this channel communication for the current transaction. The channel communication identifier may be located in the communication body or somewhere else, such as the header. The channel communication identifier may be referred to as metadata for the channel communication. The existence of metadata on both the first party and the second party communications contribute to the assurance that the first party is indeed the same user who provided the payment instrument in a prior communication, which provides adequate evidence that the same stored payment instrument can be used in the current transaction. For email, the thread identifier may be the same for both channel communications. The thread identifier may be part of a set of identifiers in the e-mail headers that are independent of the e-mail body. For a web site, the browsing session on a web site may still be active and identified by a session identifier. For SMS, the previous conversation may still be present in the SMS history. For instant message, the IM session may still be active and include the previous chat history.

In the continuation of the channel communication, a second party device 106 may send a request for payment information to complete the payment for the current transaction to first party device 104. Security system 102 may detect the request. For example, at 303, the communication may include a link that contacts security system 102. In other examples, security system 102 may be a proxy that receives each communication in 302.

When security system 102 detects the request for the second payment, a channel manager 304 in authorization engine 108 may determine whether or not the second request for payment is using a previous channel communication. For example, channel manager 304 may determine some overlapping content between the previous channel communication and the current channel communication. For example, channel manager 304 may use a channel communication identifier for the current transaction to determine whether or not the second request was sent in using an existing communication channel. In some examples, the channel identifier for the communication is used to determine if a record in storage 110 has the same channel identifier. Using the email example, an email thread may be continued from the previous transaction to the current transaction and thus includes the same thread identifier. Channel manager 304 may use the thread identifier to locate the record in storage 110 that has been stored with the payment instrument. In other examples, such as creation of a new e-mail thread, updates to an existing IM chat, adding more pictures to a conversation, more text or video messages in a video conferencing session, would not break this continuity, since there will be an overlapping subset of past communications content on both sides (first party and second party) even if the content on the first party does not match the content on the second party in its entirety. The overlapping communication content may be considered the channel identifier in this case. For example, some portions of the communication channel may match, such as usernames, messages, video, or text would match, and larger the number of matching portions, the stronger the security signal that the first party is the same.

FIG. 3B depicts an example of locating a record of a channel communication in storage 110 according to some embodiments. A table 350 includes a first column 352 that identifies payment instruments and a second column 354 that identifies channel communications. The payment instruments may be identified using different information. For example, credit cards are identified using account numbers. Also, third party payment services that transfer money for a user account may be identified using account information. As shown, information for four payment instruments, PI #1, PI #2, PI #3, and PI #4, have been stored.

Column 354 stores information for each respective communication channel. As discussed above, different information may be stored. In column 354, a communication channel identifier is stored. For example, a thread ID, To email, or username is stored. It will be understood that additional information may be stored in these entries, such as the entire thread of emails for a thread ID.

When the current channel communication is associated with a thread ID #2, channel manager 304 locates the entry shown at 356. Thread ID #2 is associated with information for a payment instrument #2 and channel manager 304 can retrieve this information from this entry from storage 110.

Referring back to FIG. 3A, a channel evaluator 306 may evaluate the strength of the channel communication being used. A strength rating quantifies how likely it is that the same user from the previous transaction is participating in the current transaction. For example, a channel evaluator 306 uses authorization rules 112 to determine a strength rating of the channel communication. In some examples, channel evaluator 306 may compare the information from the previous transaction and the current transaction with authorization rules 112 to determine the strength rating. For example, if the same thread identifier is used in the previous transaction and the current transaction, then channel evaluator 306 may determine that the strength rating is high due to the likelihood that the user is the same in both transactions. Additionally, if the same service set identifier (SSID) is used in the previous transaction and the current transaction, then the strength rating may be high because the SSID may be a unique identifier that makes it more certain that this is the same user. Other factors may also be considered, such as the use of the same To email address to the first party, the same telephone number, or the same username. However, if the same To email address is used, but not the same thread identifier, then channel evaluator 306 may determine that the strength rating is lower than if the same thread identifier was present. Similarly, if the same username is used, but the current transaction is in a new chat conversation, then channel evaluator 306 may determine that the strength rating is lower than if the same chat conversation between the second party and the username was continued.

Channel evaluator 306 may evaluate the strength rating against a threshold to determine whether or not to authorize the re-use of the payment instrument associated with the channel communication. For example, channel evaluator 306 authorizes the re-use when a strength rating meets (e.g., is above) the threshold and declines the re-use when the strength rating does not meet (e.g., is below) the threshold.

Also, in evaluating the strength rating, channel evaluator 306 may select among possible payment instruments. For example, channel manager 304 may retrieve multiple payment instruments from previous transactions for a channel communication. In some examples, the user may have used multiple payment instruments in different sessions, such as different email threads. Channel evaluator 306 may select the payment instrument that may have the highest strength rating.

If the re-use of the information for the payment instrument is authorized, then at 304, security system 102 sends a message to first party device 104 offering the re-use of the information for the payment instrument. The first party can then re-use the information for the payment instrument without re-typing the information for the payment instrument again for the current transaction and without having to submit authentication information to security system 102. For example, the first party may accept the re-use of the information for the payment instrument while still remaining anonymous to security system 102. If accepted, then the current transaction between first party device 104 and second party device 106 can be completed using the information for the payment instrument.

Mitigation

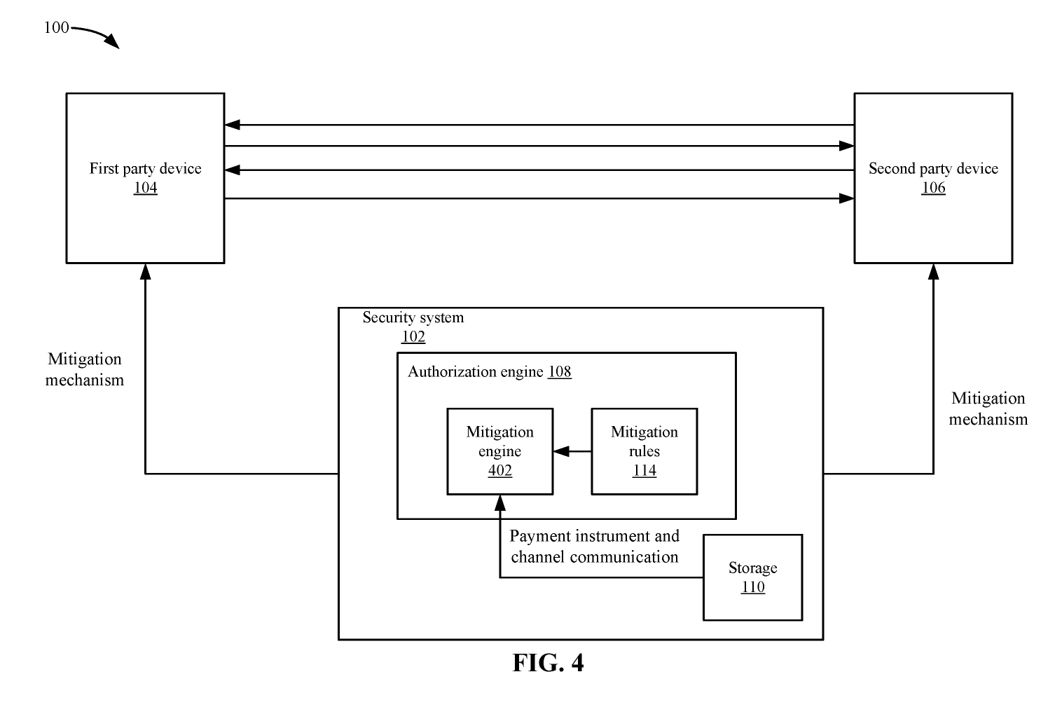

Security system 102 may also determine whether or not to perform any type of mitigation. FIG. 4 depicts an example of system 100 for performing mitigation according to some embodiments. A mitigation engine 402 may evaluate whether any mitigation mechanism may be used for the current transaction. In some embodiments, mitigation may be used based on a confidence that the same first party participated in the previous transaction and the current transaction. That is, the more confident mitigation engine 402 is that the same first party is participating in the previous transaction and the current transaction, the less likely mitigation is needed.

Mitigation engine 402 may receive information for the current transaction and/or the previous transaction. For example, mitigation engine 402 may receive the strength rating for the current transaction. Mitigation engine 402 may then use mitigation rules 114 to determine whether to apply a mitigation mechanism to the current transaction. First, mitigation engine 402 may determine whether or not to perform mitigation. For example, mitigation engine 402 may compare the strength rating to a threshold. If the strength rating is below the threshold, then mitigation engine 402 applies a mitigation mechanism and if the rating is above the threshold, then mitigation engine 402 does not apply a mitigation mechanism.

When mitigation is to be performed, mitigation engine 402 may determine different mitigation mechanisms based on different factors. For example, one factor is the communication channel. In some examples, an email communication may use a different mitigation mechanism than a phone conversation or a chat conversation. Mitigation engine 402 may also use the strength rating to select a mitigation mechanism. A lower strength rating may require more stringent mitigation. Channel evaluator 306 can also use a time-based value such that if a certain amount of time between the previous transaction and the current transaction elapses, then this channel communication cannot be used to re-use the information for the payment instrument. Further, if the second party has been associated with fraudulent activity, such as charge backs, then channel evaluator 306 may not approve the re-use of the information for the payment instrument.

If mitigation is selected, one mechanism may include sending a mitigation signal to second party device 106 to hold the funds on a second payment. Another example may include mitigation engine 402 outputting a mitigation signal to hold the funds for the second payment for a certain amount of time. This may allow the first party to complain if the charge is somehow fraudulent. In another example, mitigation engine 402 can send a mitigation signal, such as an email, to the first party indicating the payment that was used and encouraging the first party to complain if he/she does not recognize the charge. The mitigation signal may include links to the email conversation to give more context if the first party does not recognize the charge.

Mitigation engine 402 may also capture a device ID of first party device 104 and use stable machine identity that is derived from immutable hardware attached to the device in an inseparable manner, such as cryptographic random numbers or keys burned to the device's immutable storage, to increase the security. Also, mitigation engine 402 can invoke an additional security step, such as using a card verification number (CVV) or details of the previous transaction to complete the current transaction.

### Example

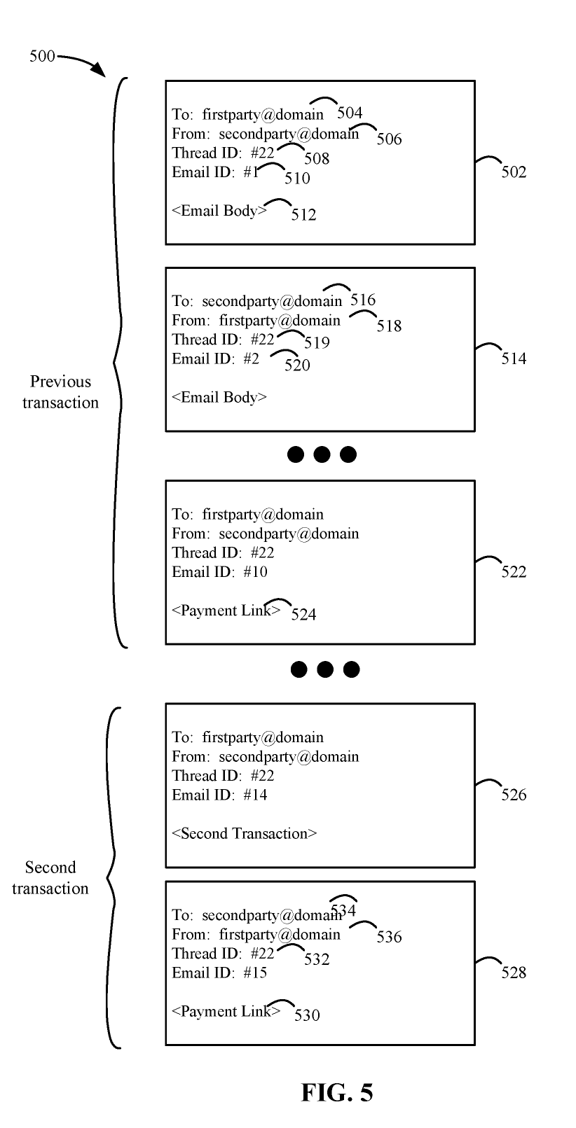

FIG. 5 depicts an example of a channel communication 500 according to some embodiments. A channel communication is an email conversation in this case. At 502, a first email is sent between a first party and a second party. In the first email, at 504, a To email address for the first party is “firstparty@domain”. At 506, a From email for the second party is “secondparty@domain”. A thread ID at 508 identifies the thread as thread #22. Also, an email ID at 510 identifies this email as email #1 in the thread. As discussed above, any emails in the thread will include the same thread ID, but the email ID may change based on the sequence of the email in the thread. At 512, the email may include some sort of body. For example, a transaction may be being performed and the body includes information for the transaction.

At 514, a second email in the thread is shown. This may be an email from the first party to the second party. For example, the To email and From email are changed in the email to indicate that the first party sent the email to the second party as shown at 516 and 518. At 519, the thread identifier is the same as thread ID #22, but at 520, the email ID has been incremented to be email ID #2.

Any number of emails may be sent in the thread and are not shown. Then, at 522, an email that requests a payment for the previous transaction from the first party is shown. At 524, a payment link is provided in the email. The first party can select the payment link, which re-directs the first party to security system 102. The first party then provides information for the payment instrument. The following assumes that security system 102 authorizes the use of the payment instrument. Then, security system 102 can store the channel communication record in addition to the information for the payment instrument. As discussed above, security system 102 may store different information that can be used to identify the channel communication. For example, security system 102 may store the thread ID for the channel communication, the To email and From email from any of the emails, and/or the entire content of the thread.

At 526, the email thread is continued for a current transaction with an email for the second transaction. Eventually, at 528, an email is received with a payment link at 530 is provided to the first party for the current transaction. This email includes the same thread ID #22 at 532 in addition to the same To email address to the first party and the same From email address from the second party at 534 and 536, respectively.

Security system 102 may detect the payment request and determine whether or not to provide to the first party the opportunity to re-use the same information for the payment instrument that was provided at 524 in the previous transaction. The evaluation described above may be used. For example, security system 102 approves the re-use because the thread ID is the same in both the previous transaction and the current transaction. Assuming the re-use is approved, the first party receives an email that offers the re-use of the payment instrument for the current transaction. The first party can accept the re-use in this case.

Method Flows

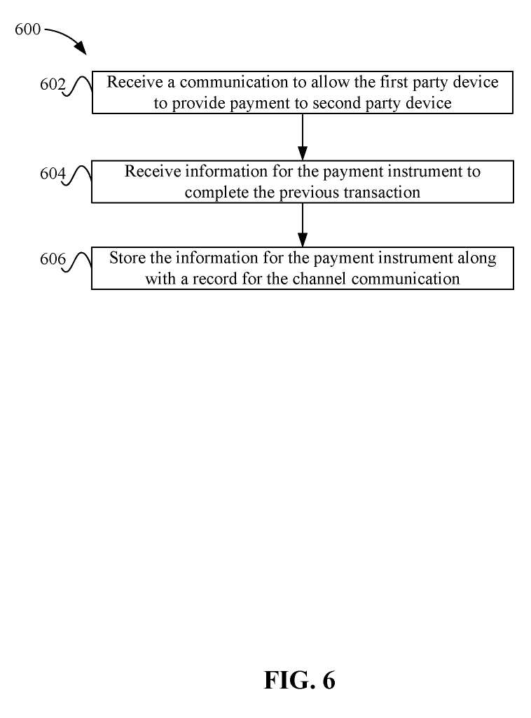

FIG. 6 depicts a simplified flowchart 600 for processing a previous transaction according to some embodiments. At 602, security system 102 receives a communication to allow the first party device 104 to provide payment to second party device 106. For example, an email may include a link that contacts security system 102 when selected.

At 604, security system 102 receives information for the payment instrument to complete the previous transaction. Security system 102 also does not require the first party to create an account or provide authentication information to save the information for the payment instrument. At 606, security system 102 stores the information for the payment instrument along with a record for the channel communication.

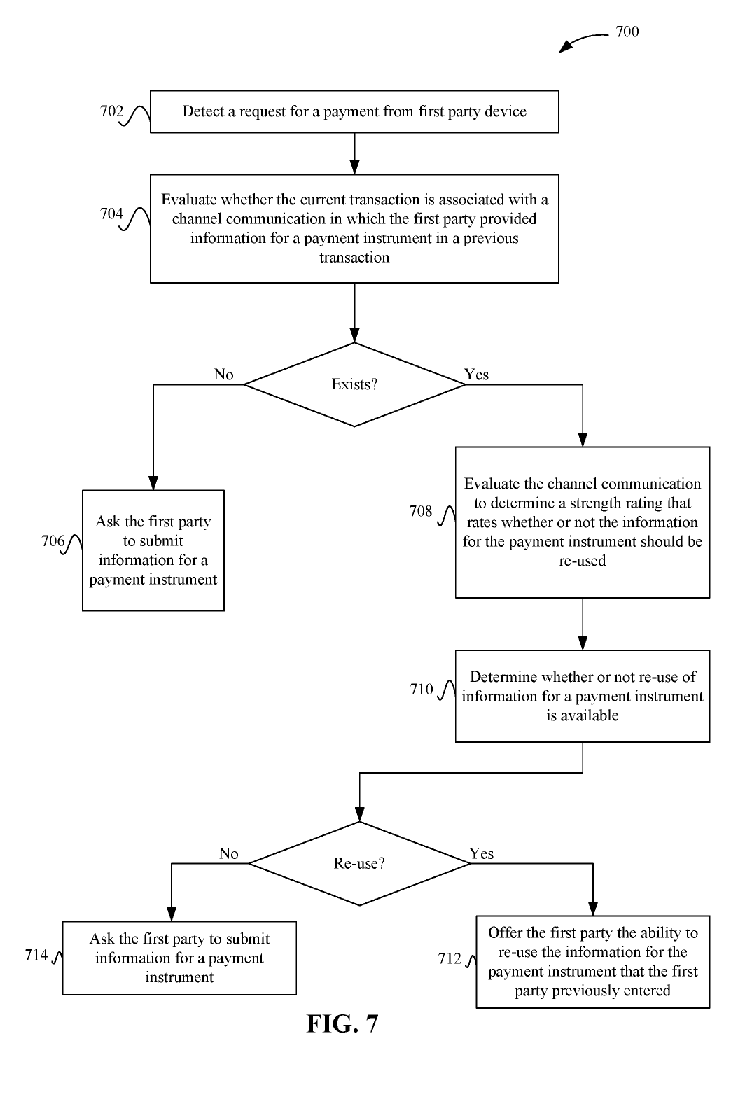

FIG. 7 depicts a simplified flowchart 700 of a method for processing a current transaction according to some embodiments. At 702, security system 102 detects a request for a payment from first party device 104. For example, second party device 106 may send an email with a request for a payment to first party device 104. The email may include a link that contacts security system 102.

At 704, security system 102 evaluates whether the current transaction is associated with a channel communication in which the first party provided information for a payment instrument in a previous transaction. At 706, if a previous channel communication does not exist, then security system 102 asks the first party to submit information for a payment instrument.

If a previous channel communication exists, at 708, security system 102 evaluates the channel communication to determine a strength rating that rates whether or not the information for the payment instrument should be re-used. At 710, security system 102 determines whether or not re-use of information for a payment instrument is available.

At 712, if re-use is available, security system 102. At 714, if re-use is not available, then security system 102 asks the first party to submit information for a payment instrument.

Accordingly, a channel communication is used to authorize the re-use of information for a payment instrument. The channel communication may authorize re-use when it is determined that the communication is delivered to the same recipient (e.g., the same email address or the same username), and the communication may not be publicly detectable, such as always transferred using a secure mechanism.

The authorization of the re-use does not require a user to sign up for a service and provide authentication information for an account. This provides faster authorization and is also more convenient for a user because the user does not need to sign up for a service and/or recall the log-in information for the service. Also, the use of the channel communication may provide security in that the security system may evaluate whether or not the same first party is participating in a subsequent transaction that allows the re-use of the information for the payment instrument.

### Example Computer System

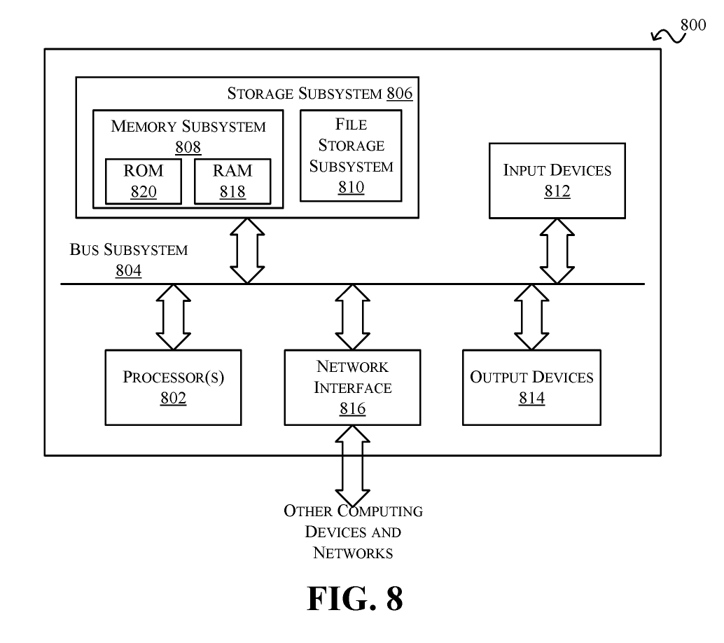

FIG. 8 depicts a simplified block diagram of an example computer system 800 for security system 102 according to certain embodiments. Computer system 800 can be used to implement any of the computing devices, systems, or servers described in the foregoing disclosure. As shown in FIG. 8, computer system 800 includes one or more processors 802 that communicate with a number of peripheral devices via a bus subsystem 804. These peripheral devices include a storage subsystem 806 (comprising a memory subsystem 808 and a file storage subsystem 810), user interface input devices 812, user interface output devices 814, and a network interface subsystem 816.

Bus subsystem 804 can provide a mechanism for letting the various components and subsystems of computer system 800 communicate with each other as intended. Although bus subsystem 804 is shown schematically as a single bus, alternative embodiments of the bus subsystem can utilize multiple busses.

Network interface subsystem 816 can serve as an interface for communicating data between computer system 800 and other computer systems or networks. Embodiments of network interface subsystem 816 can include, e.g., an Ethernet card, a Wi-Fi and/or cellular adapter, a modem (telephone, satellite, cable, ISDN, etc.), digital subscriber line (DSL) units, and/or the like.

User interface input devices 812 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 800.

User interface output devices 814 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 800.

Storage subsystem 806 includes a memory subsystem 808 and a file/disk storage subsystem 810. Subsystems 808 and 810 represent non-transitory computer-readable storage media that can store program code and/or data that provide the functionality of embodiments of the present disclosure.

Memory subsystem 808 includes a number of memories including a main random access memory (RAM) 818 for storage of instructions and data during program execution and a read-only memory (ROM) 820 in which fixed instructions are stored. File storage subsystem 810 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 800 is illustrative and many other configurations having more or fewer components than system 800 are possible.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

What is claimed is:

1. A computer system comprising:
a processor; and
a computer readable storage medium having stored thereon program code that, when executed by the processor, causes the processor to:
receive information for a first communication of a channel communication between a first party and a second party for a previous transaction in which the first party provided information for a payment instrument;
store the information for the payment instrument with the information for the first communication of the channel communication of the previous transaction in storage;
detect a current transaction between the first party and the second party using a second communication;
use information for the second communication to locate the information for the first communication of the channel communication for the previous transaction and the information for the payment instrument in the storage;
evaluate the information for the second communication and the information for the first communication of the channel communication for the previous transaction to determine whether to authorize re-use of the information for the payment instrument for the current transaction; and
provide the information for the payment instrument to the first party for use in the current transaction when the re-use of the information for the payment instrument is authorized.

2. The computer system of claim 1, wherein provide the information for the payment instrument to the first party comprises:
provide the first party an option to re-use the information for the information for the payment instrument in the current transaction.

3. The computer system of claim 1, wherein the re-use of the information for the payment instrument does not require the first party to type the information for the payment instrument in the current transaction.

4. The computer system of claim 1, wherein the re-use of the information for the payment instrument does not require the first party to create an account to re-use the information for the payment instrument when performing the previous transaction.

5. The computer system of claim 1, wherein the re-use of the information for the payment instrument does not require the first party to submit authentication information to re-use the information for the payment instrument when performing the previous transaction.

6. The computer system of claim 1, wherein when the re-use of the information for the payment instrument is not authorized, send a request for submission of information for a payment instrument to the first party.

7. The computer system of claim 1, wherein evaluate the information for the second communication and the information for the and channel communication comprises:
determine a first channel communication identifier for the previous transaction;
determine a second channel communication identifier for the current transaction; and
authorize the re-use of the information for the payment instrument when the first channel communication identifier matches the second channel communication identifier.

8. The computer system of claim 1, wherein evaluate the information for the second communication and the information for the and channel communication comprises:
determine that second communication for the current transaction is a continuation of the first communication in the channel communication from the previous transaction.

9. The computer system of claim 1, wherein evaluate the information for the second communication and the information for the and channel communication comprises:
determine a strength rating based on the information for the second communication and the information for the first communication of the channel communication for the previous transaction; and
determine whether to authorize the re-use of the information for the payment instrument based on comparing the strength rating to a threshold.

10. The computer system of claim 1, further comprising:
determine whether to perform a mitigation mechanism; and
when it is determined that the mitigation mechanism should be performed, communicate with one or more of the first party and the second party to perform the mitigation mechanism.

11. The computer system of claim 10, wherein perform the mitigation mechanism comprises:
communicate details describing the mitigation mechanism to one or more of the first party and the second party.

12. The computer system of claim 1, wherein the first communication in the channel communication and the second communication are secure communications between the first party and the second party.

13. The computer system of claim 1, wherein the first communication in the channel communication and the second communication comprises one or more of an email communication, short message service conversation, instant message conversation, and website session.

14. The computer system of claim 1, wherein the second channel communication for the current transaction includes at least a portion of the information from the channel communication for the previous transaction.

15. The computer system of claim 1, wherein the information for the first communication of the channel communication comprises content from the first communication.

16. The computer system of claim 1, wherein the information for the first communication of the channel communication comprises an identifier to uniquely identify the channel communication.

17. A method comprising:
receiving, by a computing device, information for a first communication of a channel communication between a first party and a second party for a previous transaction in which the first party provided information for a payment instrument;
storing, by the computing device, the information for the payment instrument with the information for the first communication of the channel communication of the previous transaction in storage;
detecting, by the computing device, a current transaction between the first party and the second party using a second communication;
using, by the computing device, information for the second communication to locate the information for the first communication of the channel communication for the previous transaction and the information for the payment instrument in the storage;
evaluating, by the computing device, the information for the second communication and the information for the first communication of the channel communication for the previous transaction to determine whether to authorize re-use of the information for the payment instrument for the current transaction; and
providing, by the computing device, the information for the payment instrument to the first party for use in the current transaction when the re-use of the information for the payment instrument is authorized.

18. The method of claim 17, wherein evaluating the information for the second communication and the information for the and channel communication comprises:
determining a first channel communication identifier for the previous transaction;
determining a second channel communication identifier for the current transaction; and
authorizing the re-use of the information for the payment instrument when the first channel communication identifier matches the second channel communication identifier

19. The method of claim 17, wherein evaluating the information for the second communication and the information for the and channel communication comprises:
determining that second communication for the current transaction is a continuation of the first communication in the channel communication from the previous transaction.

20. A readable storage medium having stored thereon program code executable by a computer system, the program code causing the computer system to:
receive information for a first communication of a channel communication between a first party and a second party for a previous transaction in which the first party provided information for a payment instrument;
store the information for the payment instrument with the information for the first communication of the channel communication of the previous transaction in storage;
detect a current transaction between the first party and the second party using a second communication;
use information for the second communication to locate the information for the first communication of the channel communication for the previous transaction and the information for the payment instrument in the storage;
evaluate the information for the second communication and the information for the first communication of the channel communication for the previous transaction to determine whether to authorize re-use of the information for the payment instrument for the current transaction; and
provide the information for the payment instrument to the first party for use in the current transaction when the re-use of the information for the payment instrument is authorized.
